(19) United States
(12) Patent Application Publication
(10) Pub. No.: US 2026/0217172 A1
(43) Pub. Date: Jul. 30, 2026

(54) TUNABLE COMPOSITE SEAT STRUCTURE AND TOOLING ASSEMBLY FOR FORMING THE SAME IN ORDER TO MEET CRASHWORTHINESS LOADS

(71) Applicant: U.S. Farathane, LLC, Auburn Hills, MI (US)

(72) Inventors: Timothy Michael Maly, Fenton, MI (US); Jeffrey John Page, Macomb Twp., MI (US)

(73) Assignee: U.S. Farathane, LLC, Auburn Hills, MI (US)

(21) Appl. No.: 19/460,491

(22) Filed: Jan. 27, 2026

Related U.S. Application Data
(60) Provisional application No. 63/750,376, filed on Jan. 28, 2025.

(51) Int. Cl. B60N 2/68; B60N 2/42

(52) U.S. Cl. CPC B60N 2/68; B60N 2/4263

(57) ABSTRACT

A rear row plastic injection molded vehicle seat pan and tooling assembly for forming the same having application over multiple vehicle platforms, and which includes design variations covering any of trough shaping and contouring, reconfiguration of underside stanchion supports and associated dog ear mounting locations, and variations in rib quantity, design and rib wall construction in order to modify crash impact properties to achieve varied crashworthiness ratings. The seat pan can also be formed from either of a single or dual shot injection molded material, such further including utilizing different composite polymers to assist in achieving deformation properties resulting from an impact event which correspond to a desired crashworthiness rating.

### CROSS REFERENCE TO RELATED APPLICATIONS

The present application claims priority from USSN 63/750,376 filed January 28, 2025.

### FIELD OF THE INVENTION

The present invention relates generally to vehicle seat bottom or seat pan structures. More specifically, the present invention teaches a polymeric second or rear row vehicle seat bottom pan having application over any multiple of vehicle platforms. The seat pan includes tunable design variations for a given standard sized trough shaped body. This can cover any of trough shaping and contouring, reconfiguration of underside forward edge located stanchion supports and associated dog ear mounting locations.

Other design aspects include variations in rib quantity, design and rib wall construction in order to modify crash impact properties (most notably the undesirable tendency of the seat supported occupant to submarine during an impact event), this further achieving a crashworthiness rating associated with that specific vehicle platform. As will be further described, the seat pan can also include provision of a single or dual shot injection molded seat pan, which can further utilize different composite polymer materials to assist in achieving the desired crashworthiness rating (also termed as a crash pulse defined as an acceleration curve that measures the deceleration of a vehicle during a collision).

### BACKGROUND OF THE INVENTION

Current vehicle design places a premium in achieving cost savings and reducing weight wherever possible. This is particularly applicable to electric (EV) vehicles in which it is particularly desirable to compensate for the added weight of the battery pack.

Plastic injection molded cushion or seat pans are relatively new products to the market, which seek to address the need for achieving weight and cost savings. A first example of this is the seat pan of Romer US 2016/0185265 for fastening to a seat frame of a vehicle seat. The seat pan has a profile structure made up of multiple profiles, and on its bottom side has crossbeam receptacles, preferably tube receptacles which are open at the bottom, for placement on a crossbeam, in particular a transverse tube of the seat frame, which extends in the transverse direction. The seat pan is preferably injection-molded from a plastic material, wherein through holes, which extend through the profile structure in the vertical direction are formed between the profiles, preferably between all profiles.

US 10,596,939, to Osterhoff, discloses a seating assembly includes a seat frame and a seating support cushion. An adjustable cushion pan is rotatably coupled with the seat frame. A plurality of downwardly extending connection members are integral with and extend from a bottom surface of the cushion pan. An electronic seating module is operably coupled directly to select ones of the plurality of downwardly extending connection members.

Finally, US 10,967,771 to Siebold teaches a seat support structure including an elastomeric panel for positioning and supporting an occupant.

### SUMMARY OF THE INVENTION

The present invention teaches a tunable second or rear row plastic injection molded vehicle seat pan. As previously described, the seat pan has application over any multiple of vehicle platforms, and which includes tunable design variations covering any of trough shaping and contouring, reconfiguration of underside located stanchion supports and associated dog ear mounting locations. Other aspects include design variations in rib quantity, design and rib wall construction, in order to modify crash impact properties (most notably the undesirable tendency of the seat-supported occupant to submarine during an impact event), in order to achieve varied crashworthiness ratings associated with the specific vehicle platform.

The seat pan can also be formed from either of a single or dual shot injection molded material. This can include multiple shots of plasticized material with variations in thickness and surface profiling in such as the ribs. Alternatively, multiple shot plastic seats can include different composite polymers to assist in achieving a desired deformation profile during an impact event, which corresponds to a desired crashworthiness rating (also termed a crash pulse, which is defined as an acceleration curve that measures the deceleration of a vehicle during a collision).

The present invention also discloses upper and lower mating die halves collectively defining a closed mold configuration corresponding to a trough shaped seat pan having a contoured upper side and a structurally supporting lower side. The die assembly includes a plurality of removable and interchangeable inserts installable within cavities associated with at least one of the upper and lower dies prior to closing of the same and which, upon injecting a flowable resin, forming the seat pan having a common outline with variable configuration of at least one of underside ribs, stanchions and stanchion rib walls in order to adjust an energy absorbing crash deformation profile which, in response to an impact event, achieves a controlled collapse along a desired load path

### BRIEF DESCRIPTION OF THE DRAWINGS

Reference will now be made to the attached drawings, when read in combination with the following detailed description, wherein like reference numerals refer to like parts throughout the several views, and in which:

FIG. 1 presents an underside perspective of a plastic seat pan according to a first non-limiting embodiment of the present invention;

FIG. 2 presents a one hundred and eighty degree rotated upper side view of the seat pan of FIG. 1;

FIG. 3 is a side view of a seat pan according to a non-limiting embodiment illustrating a tunable stanchion support configuration for dissipating a load path during an impact event;

FIG. 4 presents a front plan view of the seat pan such as depicted in FIG. 3 depicting the three stanchion locations which can be individually tuned according to a required load path;

FIGS. 5-10 present a series of side views corresponding to FIG. 3 and depicting a series of non-limiting alternative configurations associated with vertical rib profiles located at each stanchion and which can be individually shaped and tuned in order to deform and absorb energy during an impact event;

FIG. 11 presents a further rotated underside perspective of the plastic seat pan and depicting a rib wall pattern associated with the spaced apart ears associated with each stanchion support;

FIGS. 12-15 illustrate further alternative variations in rib pattern design for providing greater strength and reinforcement or which is designed in a non-linear fashion laterally to allow for controlled crush/collapse in order to dissipate energy during an impact event, such further contemplating a two shot plastic injection process utilizing potentially different materials;

FIG. 16 presents a slightly rotated and elevated perspective view of the seat pan shown in FIG. 4;

FIG. 17 is a top plan view of the seat pan shown in FIG. 16;

FIG. 18 is a rotated bottom plan view of the seat pan shown in FIG. 16 and similar to that previously represented in FIG. 1;

FIG. 19 is an enlarged sectional perspective view taken of area 19 depicted in FIG. 17 of a stanchion support location as viewed from an upper side of the seat pan;

FIG. 20 is an enlarged sectional perspective view taken of area 20 depicted in FIG. 18 of a stanchion support location as viewed from an underside of the seat pan;

FIG. 21 presents a plan view of a representative lower die half which, in combination with an upper mating die half, collectively define a closed mold configuration corresponding to a trough shaped seat pan having a contoured upper side and a structurally supporting lower side, a plurality of removable and interchangeable inserts being installable within cavities associated with at least one of the upper and lower dies prior to closing of the same and which, upon injecting a flowable resin, forming the seat pan having a common outline with variable configuration of at least one of underside ribs, stanchions and stanchion rib walls in order to adjust an energy absorbing crash deformation profile which, in response to an impact event, achieves a controlled collapse along a desired load path; and

FIG. 22 depicts a side closed mold arrangement utilizing upper and lower mating die halves and depicting in phantom the closed mold configuration corresponding to a trough shaped seat pan having a contoured upper side and a structurally supporting lower side.

### DETAILED DESCRIPTION OF THE PREFERRED EMBODIMENTS

With reference to the attached illustrations, the present invention discloses a tunable second or rear row plastic injection molded vehicle seat pan, the variable construction of which can provide varying load paths in response to such as an impact event. As will be further described, the present invention also discloses a corresponding die assembly for providing single or dual shot injection molded of the seat pan, such utilizing different composite polymer materials in order to modify or tune the seat construction associated with a common pan base profile, and thereby assist in achieving the desired crashworthiness rating (also termed as a crash pulse, defined as an acceleration curve that measures the deceleration of a vehicle during a collision).

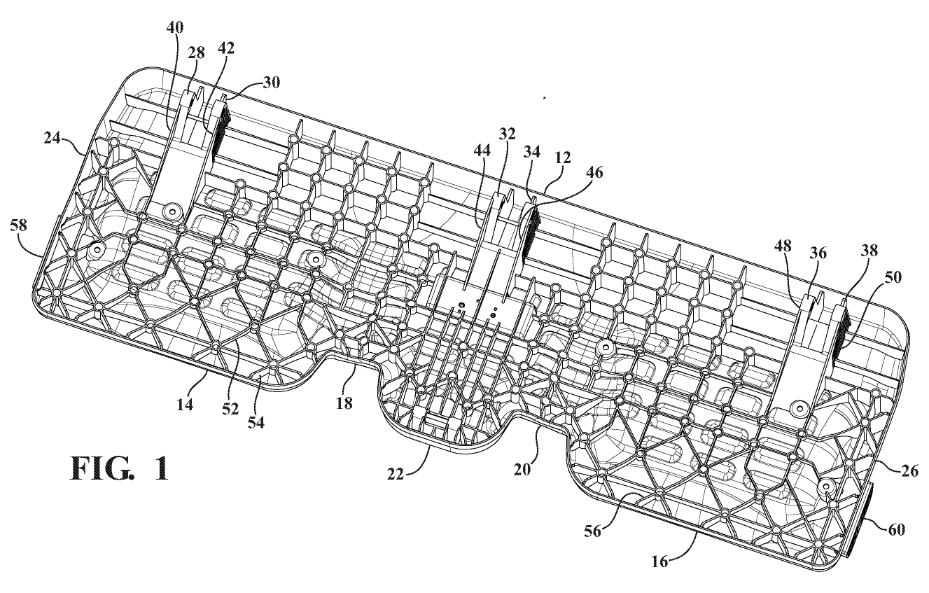

Referencing FIG. 1, an underside perspective view is shown, generally at 10, of a plastic seat pan according to a first embodiment of the present invention. As will be described with reference to the succeeding views, the present invention discloses an injection molded plastic seat pan, such as which can be formed in a single or multi (dual) shot injection molding process.

The seat pan 10 can be provided having a modified rectangular and generally four sided trough shaped body. As further depicted, a forward edge 12 of the body can include a straight extending edge, with the rear edge having an irregular profile with linear 14/16, recessed 18/20 and arcuate 22 portions. Side edges 24 and 26 interconnect the front edge 12 with the outer rear edges 14/16.

A plurality of forward underside located stanchion supports are depicted as pairs of spaced apart and associated dog ear mounting locations 28 & 30, 32 & 34, and 36 & 38, with each having associated pairs of overlaying rib walls, respectively at 40 & 42, 44 & 46,and 48 & 50. Each of the stanchion supporting rib walls, (shown in selected rib walls 42, 46 and 50) include a rib pattern which, in combination with the selected rib wall thickness, can adjust a load path or crash deformation profile responsive to an impact event for achieving a controlled collapse or deformation of the seat pan in order to modify crash impact properties, in certain instances to achieve a required crashworthiness rating associated with a specific vehicle platform.

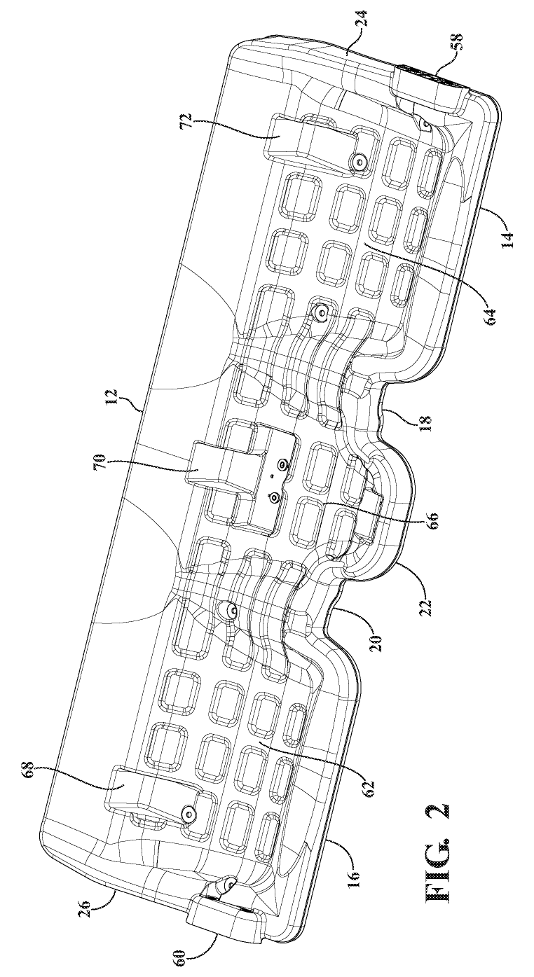

Other aspects of the seat pan underside shown in FIG. 1 include forward cross rib shaped profiles, see at 52, 54 and 56, along with seat pan trough profiles and side edge mounting locations (see at 58 and 60 in reversed upper side pan views of FIG. 2 and which can attach such as a seatback structure). Without limitation, the size, arrangement and volume of the underside ribs are variable as to rib quantity, design and rib wall construction.

Proceeding to FIG. 2, a one hundred and eighty degree rotated upper side view is shown of the seat pan of FIG. 1. The upper side contouring the plasticized seat pan is shown and which includes outer trough profiles (see at 62 and 64) along with a central profile 66. Also shown at 68, 70 and 72 are upper surface stanchion support locations which correspond to the underside stanchion features shown in FIG. 1 and again including the pairs of the dog ear mounting locations and associated rib walls.

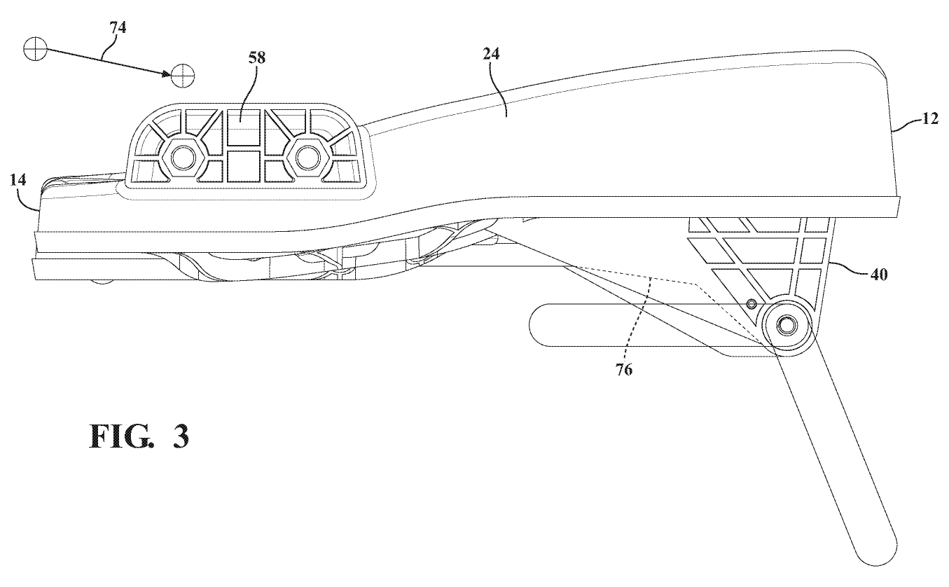

FIG. 3 provides a side view of a non-limiting variant of the seat pan and illustrating an exemplary tunable stanchion support configuration, see again selected stanchion rib wall 40 depicted in FIG. 1, for dissipating a load path during an impact event. The stanchion design is shaped and engineered to mirror an energy load path defined by the translation of the occupant starting at an H-Point (at 74) in a baseline seated position to a full travel position during a crash or impact event. The ability of the seat pan design to provide for energy absorption during a crash is critical, with the trough shaping further contributing to limiting the instance of occupant submarining (forward sliding) during the event. Each of the associated rib wall structures includes a selected underside structural profile, at 76, corresponding to each dog ear stanchion support and which is designed to adopt a desired collapse profile in order to provide tenability in the corridor/path of the energy load.

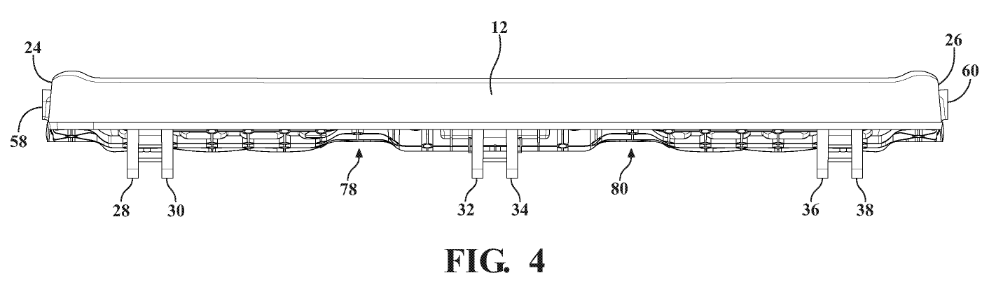

Proceeding to FIG. 4 presents a front plan view of the seat pan such as depicted in FIG. 3 depicting the three stanchion supports with pairs of dog-eared mounting locations (again at 28/30, 32/34 and 36/38) which can be individually tuned according to the required load path. As previously described in the description of FIG. 1, the corresponding stanchion defining rib walls 40/42, 44/46 and 48/50 can be modified (such as via the injection molding die process with substitutable inserts) according to any of profile, thickness and surface patterning in order to tune its desired deformation in response to the crash/impact event. As further depicted, the underside depth contouring of the seat troughs (see at 78 and 80) are depicted in the frontal plan view, it being understood that these can be modified to any desired depth or contour in order to assist in preventing submarining motion of the seated occupant in response to the forward load path.

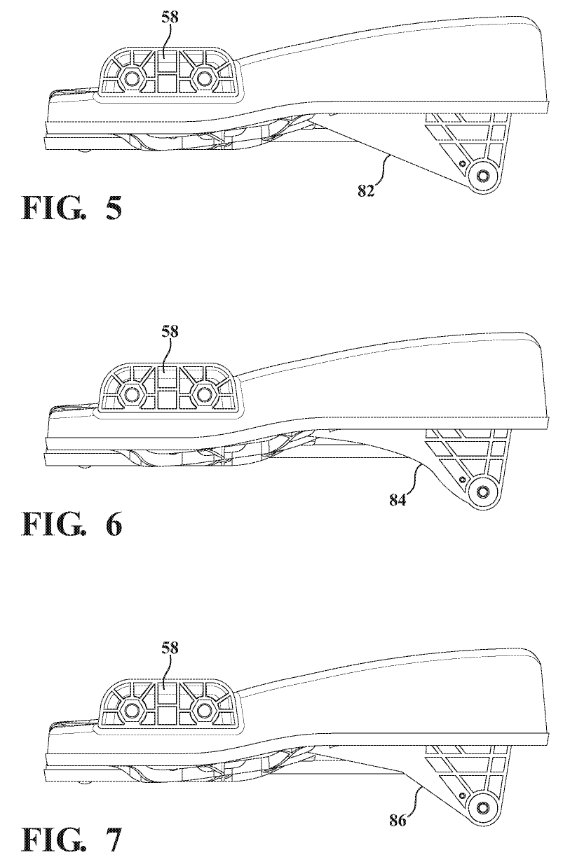

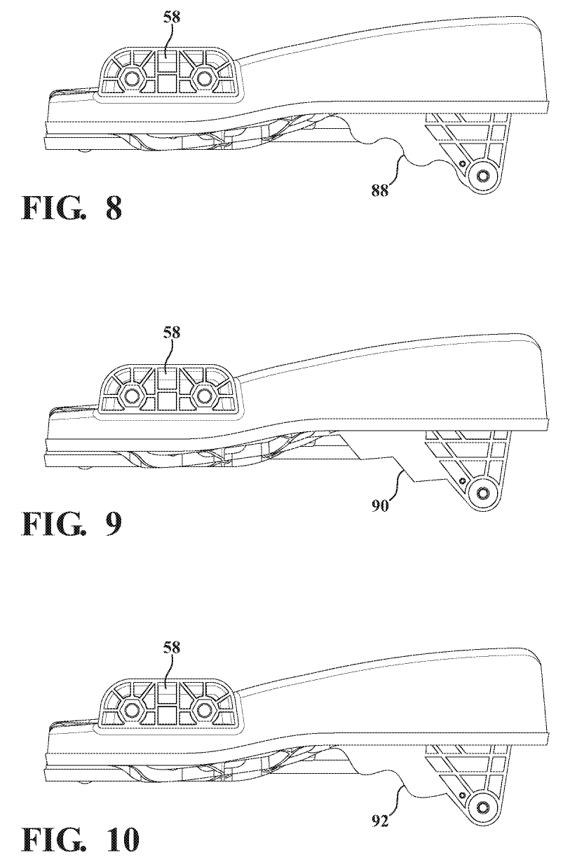

Proceeding to FIGS. 5-10, presented are a series of side views corresponding to FIG. 3 and depicting a series of non-limiting alternative configurations associated with vertical rib support profiles (see again as previously shown at 76) and located at each stanchion, see as referenced at each of 82 (FIG. 5), 84 (FIG. 6), 86 (FIG. 7), 88 (FIG. 8), 90 (FIG. 9) and 92 (FIG. 10) and which can include any of arcuate, angled or reverse bended configurations. In each instance, the rib profiles can be individually shaped and tuned as part of the associated injection molded die forming process in order to deform and absorb energy during an impact event.

As shown previously in FIG. 2 and along with the variations in the rib wall construction depicted in the succeeding embodiments, the construction of the stanchion dog ear defining rib walls can be tuned via the associated die forming process in order to exhibit a desired thickness, shaping or material construction. Additionally, the underside rib patterns (again 52, 54, 56, et. seq.) along and trough configurations can be tuned or modified as shown, again through the injection molding die process and the use of inserts in order to achieve a desired structural profile of the seat pan having a common base outline. In this manner, the tuning of the seat characteristics again enables the ability of the troughs to be shaped and contoured in order to adjust a load capability as well as establishing a reactive surface to prevent forward sliding of the seated occupant in a submarining motion.

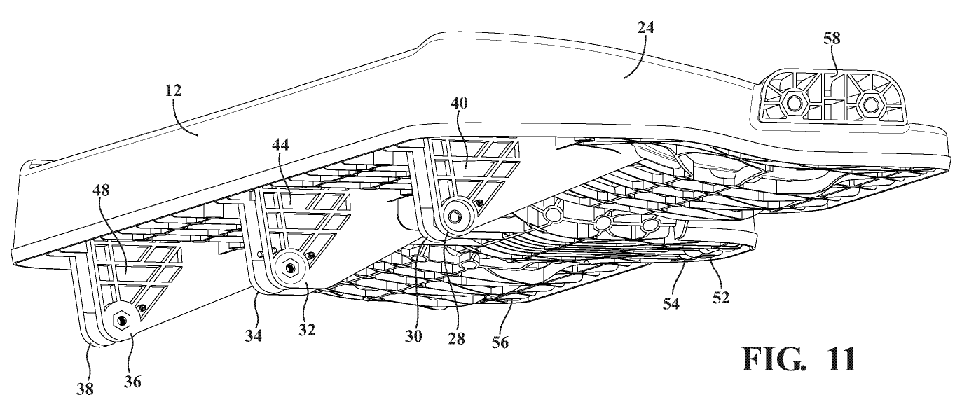

FIG. 11 presents a further rotated underside perspective of the plastic seat pan and depicting a rib wall pattern previously shown in FIG. 1 and better depicting the vertical rib wall patterns (see again at 40, 44 and 48) associated with the spaced apart ears corresponding with each pair of stanchion supports 28/30, 32/34 and 36/38.

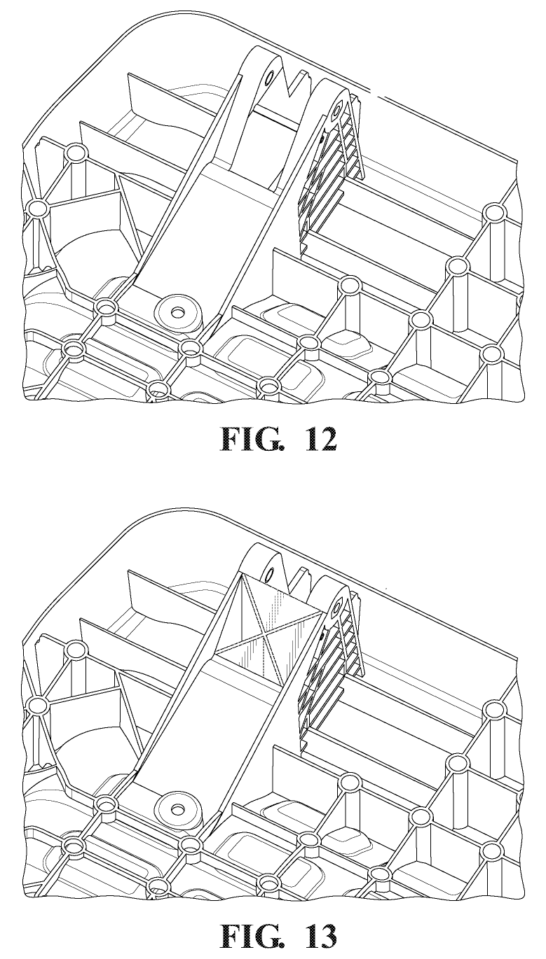

FIGS. 12-15 each depict variations in the design of the stanchion support ribs, such as for providing greater strength and reinforcement. FIG. 12 depicts a standardized rib wall configuration a first non-linear (curved or undulating) variation of rib wall design (generally at 94) to facilitate controlled crush/collapse in order to dissipate energy.

FIG. 13 depicts a cross shaped rib reinforcement 96 extending between the stanchion defining rib walls, at a location proximate to a forward connection location established between the selected stanchion and the floor of the vehicle (not shown).

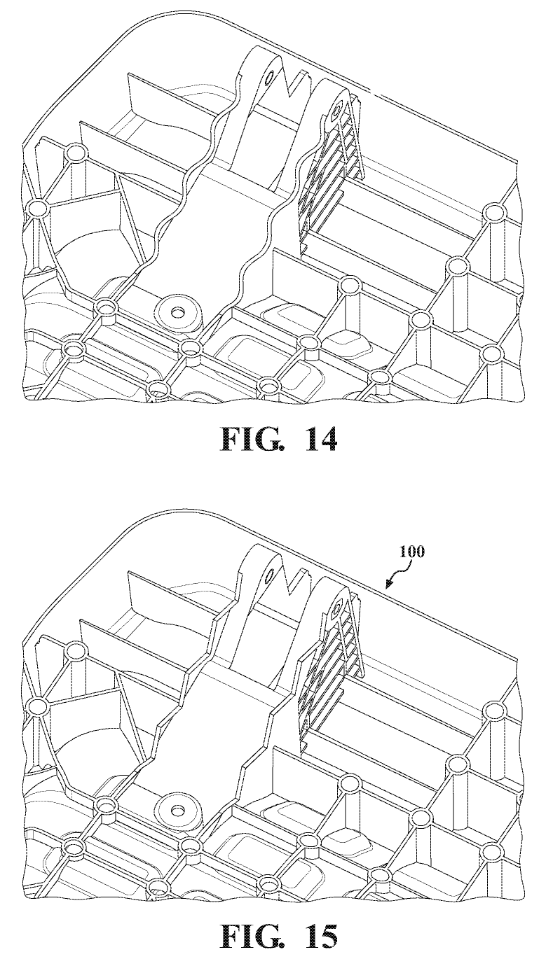

FIG. 14 depicts a second non-linear (reverse bended) variation of the stanchion support rib walls, further at 98. As previously described, the seat pan design again can include a two shot plastic injection molded process utilizing materials best suited for effectuating a desired energy absorption profile.

FIG. 15 further shows a pseudo saw tooth configuration at 100 for allowing controlled collapse of the stanchion as part of the desired energy dissipation load path or profile. The saw tooth configuration shown can be vertically or horizontally arranged without limitation and which is again made possible by the associated tooling and die assembly with substitutable inserts for producing a desired tunable seat construction with a common base pan outline.

As depicted, the rib designs can again be in a non-linear fashion laterally to allow for controlled crush/collapse in order to dissipate energy during an impact event, such further again contemplating a two shot plastic injection process utilizing potentially different materials.

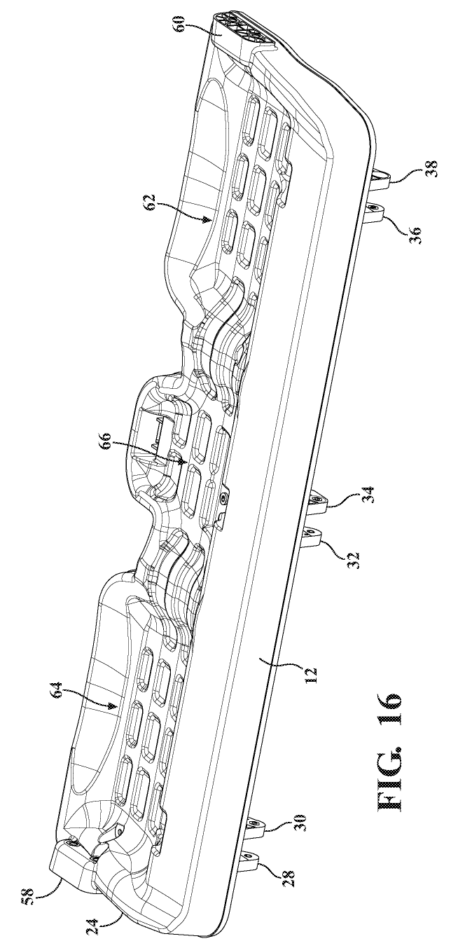

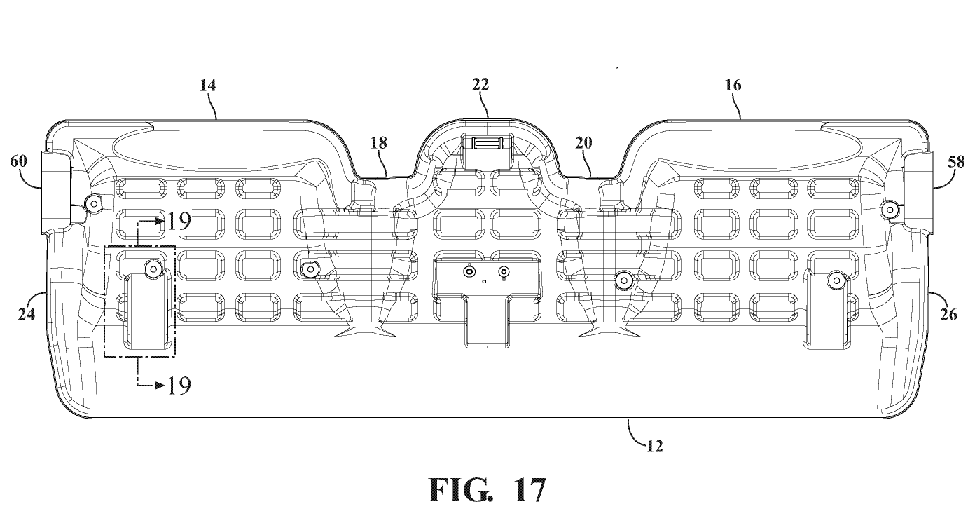

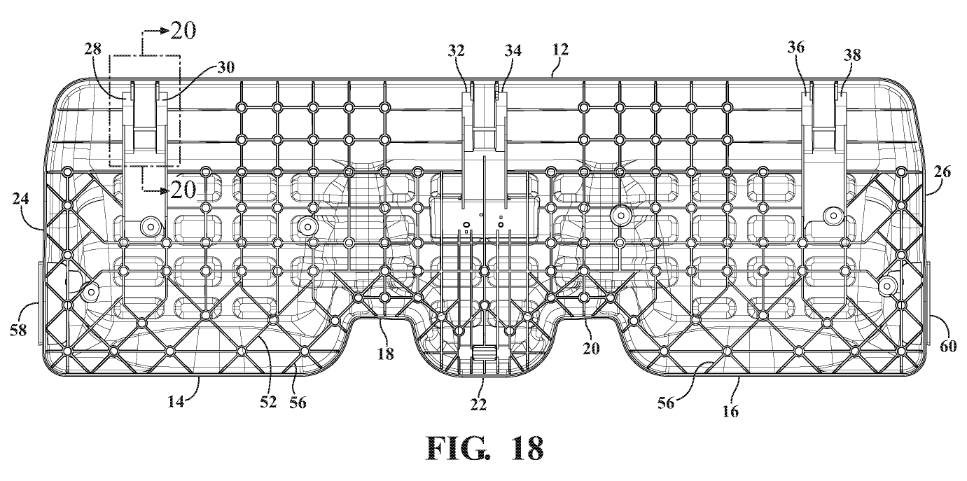

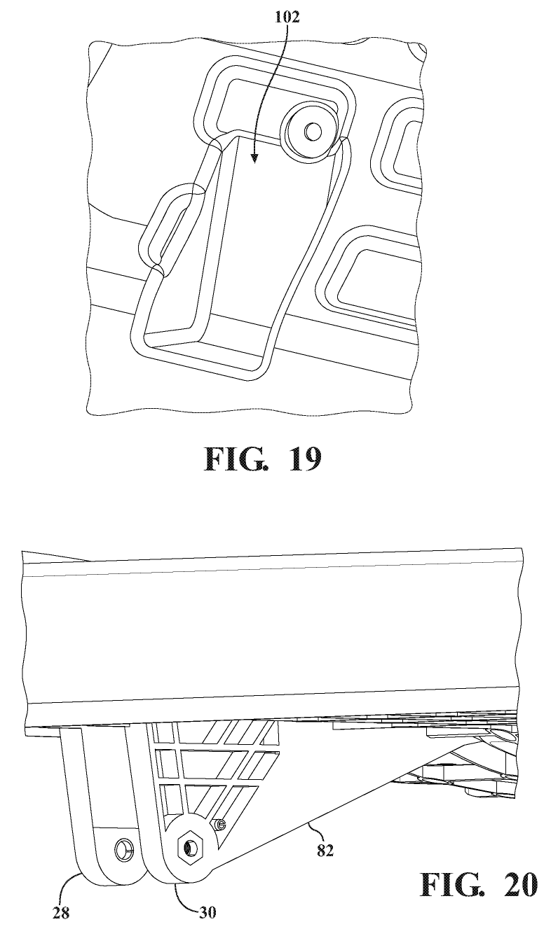

FIGS. 16-20 provide a series of upper perspective (FIG. 16), top plan (FIG. 17), bottom plan (FIG. 18), partial A side pocket (FIG. 19) and partial stanchion rib walls (FIG. 20) illustrations associated with a plastic seat pan, such as shown. In particular, FIG. 16 provides a better illustration in perspective of the upper side of the seat pan with the shallow upper surface depressions or troughs, as previously identified at 62, 64 and 66.

FIG. 19 is an enlarged sectional perspective view at 102 taken of area 19-19 depicted in FIG. 17 of a stanchion support (see at compared to at 68, 70 and 72 in FIG. 2) and as viewed from an upper side of the seat pan. The construction shown in FIG. 19 provides for strengthening the stanchion support over standard dog ear shaped designs.

FIG. 20 presents an enlarged sectional perspective view taken of area 20-20 depicted in FIG. 18 of a stanchion support location as viewed from an underside of the seat pan and including a stanchion profile (again at 82 as previously shown in FIG. 5 for providing controlled collapse of the seat pan according to the desired and tuned profile associated with its injection molded construction. Similar elements are repetitively numbered from prior illustrations, such that a repetitive description is not needed.

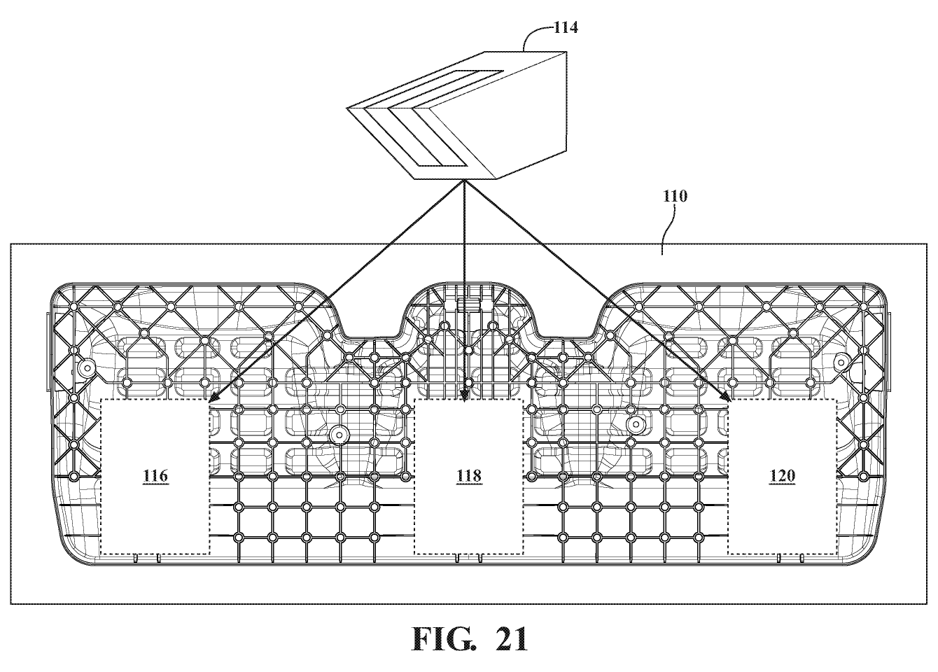

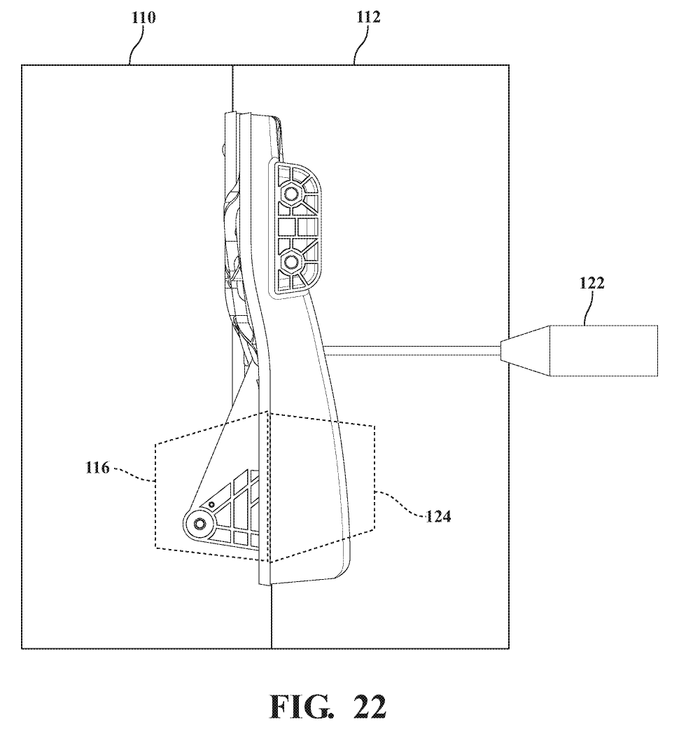

Proceeding now to FIG. 21, a plan view is presented of a representative lower die half 110 which, in combination with an upper mating die half 112 (see also closed mold in FIG. 22), collectively define a closed mold configuration corresponding to a trough shaped seat pan corresponding to the designs previously depicted and having a contoured upper side and a structurally supporting lower side. The die tooling aspect of the present invention is understood to work in tandem with the plastic computer aided engineering modeling in order to design and readily produce a plastic seat pan exhibiting a desired controlled collapse load path profile for a given vehicular application.

A plurality of removable and interchangeable inserts 114 are shown and which are installable within cavity receiving locations 116, 118 and 120 associated with at least one of the upper and lower dies (shown again by lower die 110) prior to closing of the same and which, upon injecting a flowable resin, forming the seat pan having a common outline with variable configuration of at least the stanchions and rib wall constructions and potentially the underside ribs in order to adjust an energy absorbing crash deformation profile which, in response to an impact event, achieves a controlled collapse along a desired load path.

Without limitation, any suitable resin can be provided not limited to polypropylene, polyethylene, thermoplastic vulcanizate or the like. The dimensioning and selection of resin materials utilized can further be chosen according to the desired collapse/load path properties desired by the given application.

FIG. 22 depicts a side closed mold arrangement utilizing upper 110 and lower 112 mating die halves and depicting in phantom the closed mold interior cavity configuration corresponding to a trough shaped seat pan having a contoured upper side and a structurally supporting lower side. Without limitation, the seat pan can be produced in either of single or multiple resin injection (shots) of flowable resin material, such as injected through an inlet nozzle representatively shown at 122. Also again shown at 116 and at 124 are interchangeable core and cavity inserts locations associated with the mating die halves 110/112.

In this manner, the interchangeable inserts can accommodate different geometries to adjust collapse of the seat pan based on the energy/load path. The injection mold die assembly further allows for unforeseen tool modifications and engineering changes which may be required in the event of part failure.

Without limitation, any suitable resin can be provided and, in the instance of forming a dual shot injection molded seat pan, this can include either or both the first and second shots incorporating first and second thermoplastic plastic materials, such as which exhibit differing deformation characteristics. This can include the seat pan trough sections and supporting rib structure being formed from a first base thermoplastic material, with a suitable transfer or pick and place operation transferring the intermediate formed article to a second die shot process in which a second, optionally more deformable material, being injected in order to form at least the stanchion supports and potentially other rib defined structure in order to establish a desired deformation in response to a given load path during an impact event. In this manner, the present invention avoids the need for large investments in dedicated tooling and such as which is associated with metal forming practices.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A vehicle seat pan, comprising :a trough body having a having a modified rectangular shape with a contoured upper side and a structurally supporting underside; a plurality of ribs integrated into locations along said underside of said body; a plurality of forward underside located stanchions adapted to mount said body to a floor of the vehicle, said stanchions each depicted as pairs of spaced apart mounting locations and further having associated rib walls overlaying said stanchion supports; and each of said stanchion rib walls exhibiting a reconfigurable thickness and surface pattern to adjust an energy absorbing crash deformation profile of said trough body in response to an impact event for achieving a controlled collapse along a desired load path.

2. The vehicle seat pan as described in claim 1, further comprising said trough body being formed from either of a single or dual shot injection molded material, including utilizing different composite polymers to assist in achieving deformation properties resulting from an impact event which correspond to a desired crashworthiness rating.

3. The vehicle seat pan as described in claim 1, further comprising said ribs exhibiting any variation in quantity, design and wall construction to modify crash impact properties.

4. The vehicle seat pan as described in claim 1, said plurality of ribs further comprising cross rib shaped profiles.

5. The vehicle seat pan as described in claim 1, said rib walls overlaying said stanchion supports further comprising any of an arcuate, angled or reverse bend profile.

6. A tooling assembly for creating an injection molded tunable composite seat structure for meeting varied crashworthiness loads, comprising: an upper die and a lower die which collectively define a closed mold configuration corresponding to a trough shaped seat pan having a contoured upper side and a structurally supporting lower side; and a plurality of removable and interchangeable inserts installable within cavities associated with at least one of the upper and lower dies prior to closing of the same and which, upon injecting a flowable resin, forming the seat pan having a common outline with variable configuration of at least one of underside ribs, stanchions and stanchion rib walls in order to adjust an energy absorbing crash deformation profile which, in response to an impact event, achieves a controlled collapse along a desired load path.

7. The tooling assembly of claim 6, said lower die further comprising dog-ear shaped pairs of recess profiles corresponding to underside support stanchions of the seat pan.

8. The tooling assembly of claim 7, further comprising said inserts installing within said dog-ear shaped recess profiles in order to vary a size and vertical rib wall pattern of the injection molded stanchions.

9. The tooling assembly of claim 6, said flowing resin further comprising either of a single or dual shot injection molding process which can further utilize different composite polymer materials to assist in achieving the desired crashworthiness rating.
